(19) United States
(12) Patent Application Publication
(10) Pub. No.: US 2026/0071680 A1
(43) Pub. Date: Mar. 12, 2026

(54) SEAL AND SYSTEM WITH A SEAL

(71) Applicant: STASSKOL GmbH, Stassfurt (DE)

(72) Inventors: Dennis KRANERT, Güsten (DE); Ulrich PRIEGNITZ, Magdeburg (DE); Hendrik GIERATHS, Magdeburg (DE)

(21) Appl. No.: 19/179,385

(22) Filed: Apr. 15, 2025

(30) Foreign Application Priority Data
Apr. 16, 2024 (DE) 10 2024 110 644.1

(51) Int. Cl. F16J 15/3256; F16J 15/3268; F16J 15/34

(52) U.S. Cl. CPC F16J 15/3256; F16J 15/3268; F16J 15/3452

(57) ABSTRACT

The present invention relates to a seal and a system with two mutually related components and a seal.

This application claims priority to German Patent Application No. DE 10 2024 110 644.1 filed Apr. 16, 2024, which is incorporated herein in its entirety.

### DESCRIPTION

The present invention relates to a seal and a system comprising two components rotating relative to each other and a seal.

Systems of the type mentioned at the beginning are sealed in order to prevent media from escaping in an uncontrolled manner at the boundaries between rotating and stationary components. Seals are used for this purpose. Seals can either be in the form of a single seal or as seal packings. A seal packing consists of several individual seals (also known as packing rings) arranged one behind the other in an axial direction.

Two seals for such systems are known from U.S. Pat. No. 7,040,627 B1 and U.S. Pat. No. 7,178,806 B1. U.S. Pat. No. 6,305,693 B1 discloses a seal for a system with a sealing ring which is arranged on a shaft and pressed against a sealing surface in the axial direction by compression springs. Other seals are known from EP 4 006 354 A1, U.S. Pat. No. 3,402,937, DE 699 736 C and CN 105971924 A.

The solutions known from the prior art are unsatisfactory, particularly with regard to their longterm sealing effect. The object of the invention was therefore to improve the sealing effect of seals for systems with two components rotating in relation to each other.

The solution to this object is a seal according to claim 1.

The seal according to the invention is suitable for sealing between two components rotating relative to each other. These components are either a shaft and a stator or an axle and a rotor. A shaft is a component that rotates. An axle, on the other hand, does not rotate. The global rotation is considered here, for example in an assembly or a machine system. There is relative rotation between the shaft and stator. There is also relative rotation between the axle and rotor. The shaft and axle are usually cylindrical, often elongated components.

The seal has a main ring and two side rings. These rings each have a central through hole for the axle or shaft and are arranged one behind the other along a main axis X of the seal. The main ring is arranged between the side rings. However, it is also possible for the rings to partially overlap. The main axis X is also the axis of rotation of the shaft or rotor.

Each of the side rings is in sealing contact with the main ring on the one hand and has a sealing point for sealing against the stator or the rotor on the other. The main ring has a sealing point for sealing against the axle or the shaft. The sealing points can each be a sealing line or a sealing surface. In both cases, the sealing point runs in a circle around the main axis X.

The rings are subjected to a spring force in such a way that the side rings are pressed apart in an axial direction and the main ring is pressed in the direction of the shaft or axle. In other words, the rings are subjected to a spring force in such a way that they are pressed against the respective sealing partner at their sealing points. The spring force can be exerted by at least one spring element. Accordingly, at least one spring element is preferably provided, which presses the side rings apart in the axial direction and presses the main ring in the direction of the shaft or axle.

The inventors have recognised that a simple and reliable seal can be provided in this way. The rings can each be designed in such a way that they fulfil their intended sealing function reliably and permanently. The spring force exerted on the side rings also makes it possible to readjust them in the event of wear.

The seal ensures that substances such as a lubricant are prevented from flowing along the shaft or axle.

The side rings and the main ring preferably lie against each other on surfaces that are perpendicular to the main axis X. This maximises the sealing effect between the side rings and the main ring.

When used as intended, the seal can be pressed between two contact surfaces. The main ring or a part thereof is preferably compressed in the axial direction. The main ring and the side rings then lie adjacent to each other in the axial direction. If the side rings are gradually pushed apart due to wear and the spring force (known as readjustment), the main ring relaxes over time without the sealing points between the main ring and side rings losing their sealing effect. This readjustment does not require any relative movement of the main ring on the one hand and the shaft or axle on the other, which was often necessary in the prior art and led to uneven readjustment due to the material of the main ring. Materials with a high coefficient of friction stick to the shaft/axle during such a relative movement.

Further individualisation of the individual components can be achieved by the main ring being multi-part and comprising a radially inner core ring and a radially outer ring. The side rings are then preferably in sealing contact with the core ring on the one hand and have the sealing point for sealing against the stator or rotor on the other. While the core ring preferably provides the sealing point to the shaft or axle on the one hand and to the side rings on the other hand, the outer ring, for example, can (co-)effect a preload and thus a spring force of the core ring in the direction of the shaft or axle.

According to the invention, it is provided that the main ring, in particular the core ring, does not perform any movement relative to the shaft or the axle. In the case of the shaft, the main ring/core ring therefore rotates, whereas in the case of the axle, the main ring/core ring is static. This ensures that the sealing point between the main ring/core ring and shaft/axle is kept tight, as any relative movement harbours the risk of leakage. The main ring, in particular the core ring, can be form-fitted or bonded to the shaft or axle. Both types of connection ensure particularly secure positioning of the core ring/main ring on the shaft or axle. However, it is also possible for the main ring to be frictionally attached to the shaft or axle. In this case, the main ring is preferably at least partially high-friction (high coefficient of friction) and the side rings are low-friction relative to it (low coefficient of friction). In particular, the core ring is high-friction and the side rings are low-friction. The outer ring can also be lower in friction than the core ring, as it is sufficient if only the core ring is made of a high-friction material. Since both the main ring/core ring and the side rings provide sealing points, the aforementioned selection of friction coefficients ensures that the main ring does not move relative to the shaft or axle, while the side rings can move relative to the rotor or stator.

The main ring, in particular the core ring, is at least partially made of an elastomer. Elastomers are friction-rich, i.e. have a high coefficient of friction. The side rings are preferably made of a PTFE-based material, a PEEK-based material or a carbon-based material. These materials have low coefficients of friction. Carbon-based materials in particular are well suited for high-temperature applications and also have good sliding properties under these circumstances.

‘Based’ here means that the material either consists of the substance in question or comprises it and other substances, such as fibres. Carbon-based materials (also known as carbon materials) are in particular materials that contain various forms of carbon such as coke, graphite, carbon black or carbon fibres as their main component.

As mentioned, the outer ring does not need to have a high coefficient of friction and can therefore consist of a PTFE-based material, a PEEK-based material or a brass-based material. In order to enable the outer ring to preload the core ring, the outer ring is preferably made of a material with a modulus of elasticity <10,000 MPa. A material with a low modulus of elasticity causes the spring forces to have a stronger effect.

In advantageous embodiments, the main ring, in particular the core ring, is manufactured undersized in relation to the axle or shaft. The central through hole of the main ring is then smaller than the outer diameter of the shaft or axle in the relaxed state. There is then an interference fit between the main ring and the shaft or axle after assembly. This procedure is particularly suitable if the main ring or the core ring is arranged on the shaft or axle in a force-fit manner. The press fit reinforces the sealing point to the shaft/axle.

In advantageous embodiments, the main ring is mirror-symmetrical, in particular on a plane perpendicular to the main axis X and especially in the assembled state. This embodiment makes it possible to design the side rings to be identical in construction and to arrange them mirrored on the main ring. The identical design of the side rings makes their manufacture more cost-effective.

As mentioned above, the side rings are pressed apart by an axially acting spring force and the main ring is pressed against the shaft or axle by a spring force acting in the radial direction. These two spring forces can be caused by different spring elements. However, the design of the seal according to the invention can be simplified by designing and arranging a spring element in such a way that it causes both an axial and a radial force. In advantageous embodiments, it is therefore provided that the main ring, in particular the outer ring, has at least one inclined outer circumferential surface which faces a side ring. The inclined outer circumferential surface can be used to divide or redirect a force. An outer circumferential surface is considered to be inclined in particular if it runs at an angle >0° and <90° to the main axis X. The inclined outer circumferential surface is preferably part of a lateral surface of a cone, which is essentially clamped around the main axis X and essentially has a base surface perpendicular to the main axis X. Due to the undersized design, slight deviations may occur, but these are acceptable. For uniform force distribution, it is particularly advantageous if the main ring has two inclined outer circumferential surfaces, each of which faces one of the side rings.

The spring element is preferably a garter spring. The garter spring can be arranged between the inclined outer circumferential surface and the side ring. In this case, it is supported on the inclined outer circumferential surface on the one hand and the side ring on the other. As a result, it exerts both an axial force on the side ring and a radial force on the main ring. In the case of two inclined outer circumferential surfaces, two garter springs are preferably provided as spring elements, each of which is arranged between one of the inclined outer circumferential surfaces and the side ring facing it. This leads to an even distribution of force, which can prevent the main ring from tilting.

Depending on how inclined the outer circumferential surface is, the force is divided into axial spring force and radial spring force. Very small or very large angles have proven to be insufficient and unfavourable in terms of force distribution. The inclined outer circumferential surface therefore preferably forms an angle of between 15° and 85° with the main axis X. The choice of angle also depends on the other properties of the seal. If, for example, the main ring is bonded or form-fittingly connected to the shaft or axle, no significant radial spring force is required. In this case, the angle can be quite large, for example between 60° and 85°. If, on the other hand, a material that is subject to heavy wear is used for the side rings, the axial spring force can be reduced by selecting a small angle, for example between 5° and 30°. An angle between 30° and 60° represents a good compromise between the two properties.

For easier assembly of the side rings, it is preferable for at least one side ring to be multi-part. For example, the side ring can be made up of several ring segments, whereby the ring segments can preferably be connected to each other in a force-fit or form-fit manner, for example by screwing or by a puzzle connection.

The seal according to the invention is constructed in such a way that a relative movement can take place between the side rings on the one hand and the stator or rotor on the other. In order to ensure that the relative movement takes place in the area of the sealing points of the side rings and that the side rings do not rotate with the rotor or remain stationary with the stator, advantageous embodiments provide for at least one side ring to be form-fitted with the main ring, in particular the core ring, in the circumferential direction. It is not absolutely necessary that the side ring and main ring or core ring do not allow any relative rotation. In particular, there can be a form-fit engagement that does, however, allow a certain amount of play. As the shaft or rotor only rotates in one direction in most applications and does not change direction, the side ring is then in permanent contact with the main ring on one flank during rotation, whereas an opposite flank has a gap in the circumferential direction to the main ring or core ring.

For the form-fit between the main ring and side ring, advantageous embodiments provide that the main ring has at least one axial projection that projects into an axial receptacle of one of the side rings, or vice versa. This results in a form-fit connection in the circumferential direction, which prevents undesired relative rotation between the main ring and side ring as described above. The shape of a Reuleaux triangle has proven to be particularly advantageous in terms of manufacturability, force transmission and service life for the axial projection and the axial receptacle. A particularly effective form-fit connection is achieved if the axial projection and the axial receptacle each run around the through hole. However, several individual connections are also possible.

In advantageous embodiments, the outer ring has a gap in the circumferential direction. This initially makes it easier to mount the outer ring on the core ring. It also enables the outer ring to act as a spring element. In advantageous embodiments, the outer ring is produced undersized in relation to the core ring for this purpose. In the relaxed state, the outer ring has an inner diameter that is smaller than the outer diameter of the core ring, in particular of the core ring in the assembled and/or relaxed state.

The core ring is preferably in one piece and interrupted in the circumferential direction and has two ends that can be connected to each other in a form-fit manner. This allows the core ring to be closed in the circumferential direction. A one-piece design facilitates assembly, as it is not necessary to provide two components that fit together. As the core ring is often made from an elastomer and is therefore flexible, the core ring can also be easily assembled if it is in one piece. The ends can include an acceptable deviation of the core ring from the mirror-symmetrical design. When mounted, the core ring is nevertheless preferably mirror-symmetrical.

The object of the invention is also solved by a system with two components rotating relative to each other and a seal as described above. In particular, the components are a shaft and a stator or an axle and a rotor. The stator or the rotor forms two contact surfaces in the system, each of which is in sealing contact with one of the side rings. The sealing point of the side rings is then located between the side ring and the associated, i.e. directly neighbouring, contact surface. The sealing point of the main ring or core ring is therefore formed between the main ring/core ring and the shaft or axle.

In advantageous embodiments, the seal is pressed between the contact surfaces. In particular, the main ring or core ring is compressed in the axial direction. The main ring or core ring and the side rings then lie adjacent to each other in an axially sealing manner. If the side rings are gradually pressed apart due to increasing wear, the main ring or core ring relaxes over time without the sealing point between the main ring or core ring and side ring losing its sealing effect.

In advantageous embodiments, the rotor or the stator forms a housing for the seal or has such a housing. This allows the seal to be compressed and pressed in a predefined manner. For this purpose, the housing preferably has an inner length measured along the main axis X, which is smaller than the total length of the seal measured along the main axis X (outer surface of one side ring to outer surface of the other side ring) in the relaxed state. The housing can also have an inlet for a sealing or flushing gas.

If the seal has an inclined outer circumferential surface and a garter spring is arranged on this outer circumferential surface, the garter spring is expanded outwards and pretensioned when the seal is pressed between the contact surfaces. As a result, when used as intended, the garter spring exerts an even stronger radial spring force on the main ring or the core ring and an axial spring force on the side rings.

The invention is illustrated and explained by way of example in the drawings. The following figures are shown in the drawings:

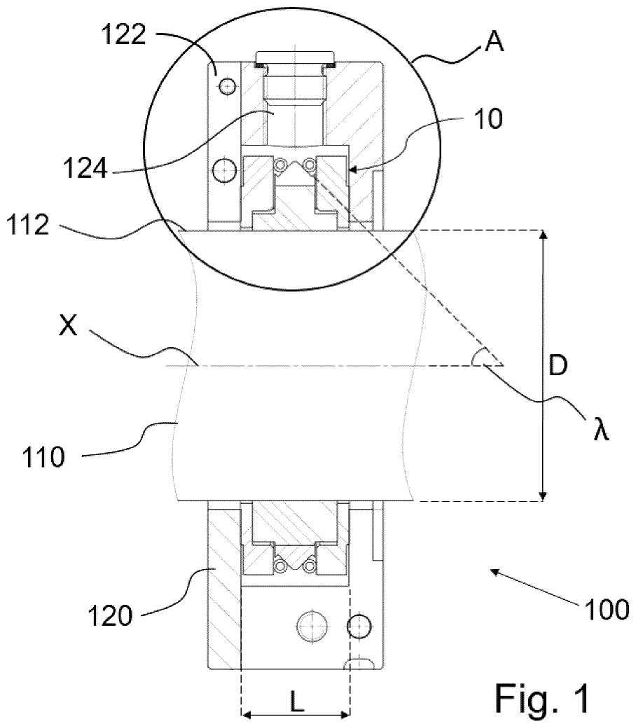

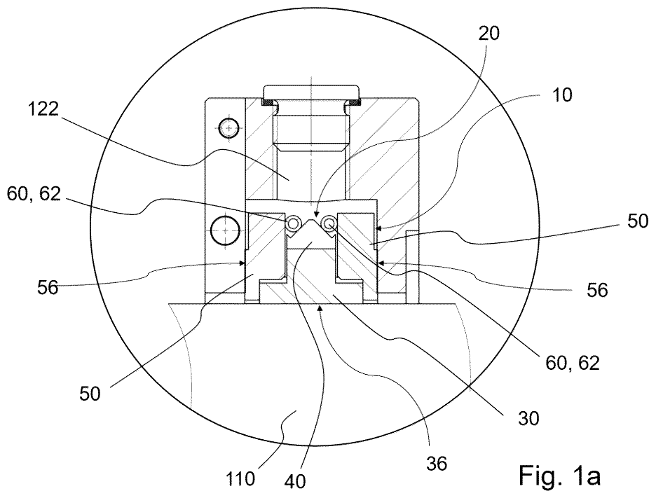

FIG. 1 a system with a seal according to a first embodiment in a sectional view,

FIG. 1a an enlarged view of the detail A of FIG. 1,

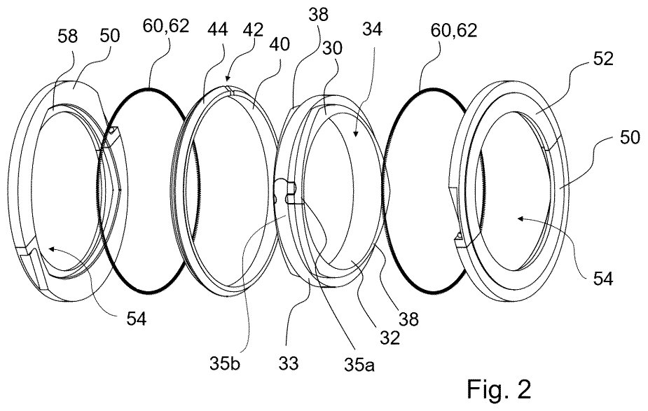

FIG. 2 an exploded view of the seal of FIG. 1 in perspective view and

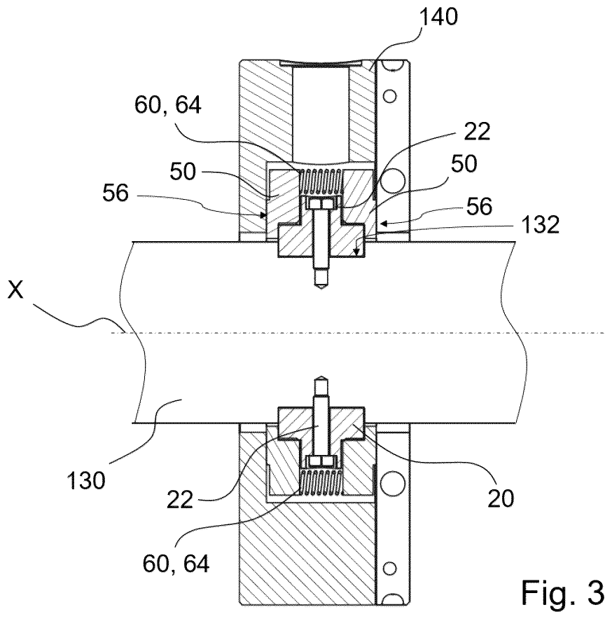

FIG. 3 is a sectional view of a system with a seal according to a second embodiment.

The system 100 shown in FIG. 1 has a centrally arranged shaft 110 and a stator 120. The stator 120 is arranged around the shaft 110. When used as intended, the shaft 110 rotates about its main axis X. The stator 120 does not rotate. Therefore, shaft 110 and stator 120 rotate relative to each other. The stator 120 comprises a housing 122 for a seal 10. An inlet 124 for flushing gas is provided in the housing 122. In the embodiment shown here, the inlet 124 is closed by a screw-in plug and can be opened if necessary if additional sealing gas is to be connected. This allows additional safety to be achieved.

FIG. 1a shows the structure of the seal 10. The seal 10 comprises a main ring 20 and two side rings 50. The main ring 20 in turn has a core ring 30 and an outer ring 40. The main ring 20 and the side rings 50 are arranged one behind the other along the main axis X, with the main ring 20 being arranged between the side rings 50. The outer ring 40 is arranged radially outside the core ring 30. As can be seen from FIG. 2, the core ring 30 has a through hole 34 and the side rings each have a through hole 54. The shaft 110 extends in the system 100 through the through holes 34, 54.

In FIG. 1a, it can be seen that each side ring 50, on the one hand, bears sealingly against the main ring 20, namely its core ring 30, and, on the other hand, has a sealing point 56 for sealing against the stator 120. The sealing point 56 is located on an axial outer surface 52 of the respective side ring 50. The core ring 30 has a sealing point 36 on its radially interior circumferential surface 32 for sealing against the shaft 110. The outer ring rests on a radially outer circumferential surface 33 of the core ring 30.

In this embodiment, the core ring 30 is made of an elastomer. It is also one-piece and interrupted in the circumferential direction and has two ends 35a, 35b, which can be connected to each other in a form-fit manner (see FIG. 2). The inner diameter of the core ring 30, i.e. the diameter of the interior circumferential surface 32, is smaller in the relaxed state than an outer diameter D of the shaft 110. If the core ring 30 is arranged on the shaft 110, there is an interference fit between these components. As a result, the core ring 30 is held firmly on the shaft 110.

The main ring 20 has a mirror-symmetrical design on a plane perpendicular to the main axis X. The side rings 50 are identical in construction, but are arranged mirrored on the main ring 20. As can be seen from FIG. 2, the side rings 50 are multi-part. Each side ring 50 consists of two parts that are screwed together for assembly.

In the embodiment shown here, the side rings 50 are made of a PTFE-based material. This material has low friction compared to the elastomer material of the core ring 30. If the shaft 110 rotates during intended use, the frictionally engaged core ring 30 attached to the shaft 110 is also rotated. Since the core ring 30 and the side rings 50 are in firm contact with each other, the side rings 50 are also rotated. Due to the low coefficient of friction of the side rings 50, these rotate at their sealing points 56 relative to the stator 120.

In the embodiment shown here, the outer ring 40 is made of a PEEK-based material. As can be seen from FIG. 2, the outer ring 40 is in one piece and has a gap 42 in the circumferential direction. The inner diameter of the outer ring 40 is smaller than the outer diameter of the core ring 30 in the assembled state, in which the core ring 30 is attached to the shaft 110. For assembly, the outer ring 40 is therefore stretched, which is possible due to the gap 42. The outer ring 40 is then arranged on the outside of the core ring 30. Due to the dimensioning, the outer ring 40 cannot fully deform back into the relaxed state and thus exerts a radially inward force on the core ring 30. This results in the core ring 30 being pressed even more firmly onto the shaft 110.

The outer ring 40 has two inclined outer surfaces 44. The inclined outer circumferential surfaces 44 each run at an angle A of approximately 45° relative to the main axis X (see FIG. 1). Each of the outer circumferential surfaces 44 faces a side ring 50. As a result, a groove extending around the main axis X is formed in each case between an outer circumferential surface 44 and a side ring 50.

A garter spring 62 is arranged in each of these grooves as a spring element 60. The garter springs 62 are an endless spiral spring which extends in a circular shape. The garter springs 62 are dimensioned in such a way that they must be expanded so that they can be arranged in the grooves. The garter springs 62 thereby primarily cause a radially inwardly directed spring force on the outer ring 40 and thereby on the core ring 30. The core ring 30 is thereby pressed further against the shaft 110. Due to the inclined outer circumferential surfaces 44, part of the inwardly directed spring force of the garter springs 62 is deflected and acts in the axial direction on the side rings 50. The side rings 50 are thereby pressed apart in the axial direction and, in particular, pressed against an inner side of the housing 122. This increases the sealing effect at the sealing points 56.

The housing 122 has a free space on the inside, which has a length L in the axial direction. In the relaxed state, the two side rings 50 and the core ring 30 have a total length along the main axis X that is greater than the length L. If the seal 10 is arranged in the housing 122, the side rings 50 and the core ring 30 are therefore pressed together in the axial direction. In particular, the core ring 30 is compressed due to its elastomeric properties. This also increases the sealing effect at the sealing points 56 and at the sealing points between the side rings 50 and the core ring 30.

The core ring 30 has two axial projections 38, which have the shape of a Reuleaux triangle and extend around the through hole 34. The side rings 50 each have an axial receptacle 58, which also have the shape of a Reuleaux triangle and extend around the through hole 54. The axial projections 38 and the axial receptacles 58 are of complementary design. In the assembled state (see FIG. 1), the axial projections 38 each project into an axial receptacle 58. In this way, the core ring 30 and the side rings 50 are form-fitted to one another in the circumferential direction. This ensures that when the shaft 120 rotates, the side rings 50 also rotate in addition to the core ring 30.

FIG. 3 shows another embodiment of a system 100. In this embodiment, the system 100 comprises an axle 130 and a rotor 140. The centrally arranged axle 130 is static here and the rotor 140 arranged around the axle 130 rotates when used as intended.

A seal 10 is arranged inside the rotor 140 and comprises a main ring 20 and two side rings 50. In this embodiment, the main ring 20 is in one piece. However, like the core ring 30 of the first embodiment, it is interrupted in the circumferential direction and has two complementary ends which can be connected to one another in a form-fitting manner. In this embodiment, the main ring 20 is connected to the axle 130 by means of screws 22 via form-fit and force-fit. For this purpose, the axle 130 has a groove 132 extending in the circumferential direction, in which the main ring 20 is arranged.

The force-fit and form-fit connection of the main ring 20 and axle 130 ensures that the main ring 20 is also static.

The main ring 20 is designed with mirror symmetry on a plane perpendicular to the main axis X. The side rings 50 have an identical design and are each in sealing contact with the main ring 20. The side rings 50 also each bear against sealing points 56 on an inner side of the rotor 140. A spring element 60 in the form of a compression spring 64 is provided to reinforce the sealing effect at these sealing points 56. The compression spring 64 acts directly on the side rings 50 and presses them apart in an axial direction.

The seal 10 ensures that substances such as a lubricant can flow along the shaft 110 or the axle 130.

Reference list

| | |
|---|---|
| 10 | Seal |
| 20 | Main ring |
| 22 | Screw |
| 30 | Core ring |
| 32 | Interior circumferential surface |
| 33 | Exterior circumferential surface |
| 34 | Through hole |
| 35a, 35b | End |
| 36 | Sealing point |
| 38 | Axial projection |
| 40 | Outer ring |
| 42 | Gap |
| 44 | Outer circumferential surface |
| 50 | Side ring |
| 52 | Outer surface |
| 54 | Through hole |
| 56 | Sealing point |
| 58 | Axial receptacle |
| 60 | Spring element |
| 62 | Garter spring |
| 64 | Compression spring |
| 100 | System |
| 110 | Shaft |
| 112 | Shell |
| 120 | Stator |
| 122 | Housing |
| 124 | Inlet |
| 130 | Axle |
| 132 | Slot |
| 140 | Rotor |
| D | Diameter |
| L | Length |
| X | Main axis |
| λ | Angle |

1. A seal for sealing between two components rotating relative to each other,
wherein the seal comprises a main ring and two side rings,
wherein the rings each have a central through hole for a first of the two components and are arranged one behind the other along a main axis X,
wherein the main ring is arranged between the side rings,
wherein each side ring, on the one hand, bears sealingly against the main ring and, on the other hand, has a sealing point for sealing against a second of the two components,
wherein the main ring has a sealing point for sealing against the first of the two components, and
wherein the rings are subjected to a spring force in such a way that the side rings are pressed apart in the axial direction and the main ring is pressed in the direction of the shaft or axle.

2. The seal according to claim 1, wherein the main ring is multi-part and comprises a radially inner core ring and a radially outer ring,
wherein the side rings each bear sealingly against the core ring on the one hand and have a sealing point for sealing against the second of the two components on the other hand.

3. The seal according to claim 1, wherein the main ring is attached to the first of the two components in a form-fitting or bonded manner.

4. The seal according to claim 1, wherein the main ring is at least partially high-friction and the side rings are low-friction.

5. The seal according to claim 2, wherein the main ring consists at least partially of an elastomer and/or the side rings consist of a PTFE-based material, a PEEK-based material or a carbon-based material and/or the outer ring consists of a PTFE-based material, a PEEK-based material or a brass-based material.

6. The seal according to claim 1, wherein the main ring is manufactured undersized in relation to the first of the two components and is thus seated frictionally on the first of the two components.

7. The seal according to claim 1, wherein the main ring is mirror-symmetrical and the side rings are identical in construction but arranged mirrored.

8. The seal according to claim 1, wherein the main ring has at least one inclined outer circumferential surface which faces one of the side rings.

9. The seal according to claim 8, wherein a spring element creating the spring force is a garter spring which is arranged between the inclined outer circumferential surface and at least one of the side rings.

10. The seal according to claim 1, wherein at least one of the side rings is multi-part.

11. The seal according to claim 1, wherein at least one of the side rings is form-fitted with the main ring in the circumferential direction, wherein the main ring has at least one axial projection which projects into an axial receptacle of the at least one of the side rings, or vice versa.

12. The seal according to claim 2, wherein the outer ring has a gap in the circumferential direction.

13. The seal according to claim 2, wherein the main ring and/or the core ring is in one piece and is interrupted in the circumferential direction and has two ends which can be connected to one another in a form-fitting manner.

14. A system comprising:
two components rotating relative to one another, wherein the two components are a shaft and a stator or an axle and a rotor; and
the seal according to claim 1,
wherein the stator or the rotor forms two contact surfaces against each of which one of the side rings bears in a sealing manner.

15. The system according to claim 14, wherein the stator or the rotor forms a housing for the seal and has an inlet for a sealing or flushing gas.

16. The seal according to claim 1, wherein the two components are a shaft and a stator or an axle and a rotor.

17. The seal according to claim 2, wherein the outer ring of the main ring, has two inclined outer circumferential surfaces which each face one of the side rings.

18. The seal according to claim 17, wherein two garter springs are provided as spring elements creating the spring force, which are each arranged between one of the inclined outer circumferential surfaces and the side ring facing it, wherein the inclined outer circumferential surface forms an angle of between 15° and 75° with the main axis X.

19. The seal according to claim 11, wherein the axial projection and the axial receptacle have the shape of a Reuleaux triangle and/or extend around the through hole.

20. The system according to claim 14, wherein the seal is pressed between the contact surfaces.
